(19) United States
(12) Patent Application Publication
(10) Pub. No.: US 2008/0283512 A1
(43) Pub. Date: Nov. 20, 2008

(54) Wilding electrode driving system

(76) Inventor: Qi Fen Jiang, Richmond Hill (CA)

Correspondence Address: DAVID W. WONG, 46 WILLOWBROOK ROAD, THORNHILL, ON, L3T 4W9, CA

(21) Appl. No.: 11/803,384

(22) Filed: May 15, 2007

(51) Int. Cl. B23K 9/133

(52) U.S. Cl. 219/136

(57) ABSTRACT

An electrode driving system for welding device has two mirror image carriages are located side by side to one another and mounted to a main frame. Each carriage has an elongated slider rod therein movable in a reciprocating manner relative to the carriage. The front portion of the slider rod has narrow sections formed by depressions located on its opposite upper and lower edges. A plurality of pairs of jaw elements are pivotally mounted in the carriages. The jaw elements are in contact engagement with the upper and lower edges of the slider rod and they are in a closed position to clamp on or release the clamp on the welding electrode while the carriages are alternately moving back and forth in the reciprocating manner for driving said electrode continuously forward toward a workpiece.

### BACKGROUND OF THE INVENTION

1. Field of the Invention

The present invention relates to a reciprocating driving system for advancing a continuous welding electrode in a welding device towards the workpiece continuously in the welding operation.

2. Background Art

A continuous electrode is employed in carrying out high quality welding operations. The welding electrode consists of a continuous metal core provided with a coating of welding flux material which has current applying gaps formed in even intervals therein exposing the metal core of the electrode. The gaps provide multiple welding current feeding points for supplying the welding current efficiently to the metal core of the welding electrode for the welding operation. In use, the welding electrode is driven by a welding device which feeds the electrode towards the workpiece continuously as well as provides the welding current through the current applying gaps to the metal core of the electrode.

U.S. Pat. No. 5,603,855 issued to C. Y. Ni shows a continuous welding electrode welding device in which a plurality of current conducting elements are circulated between two parallel tracks. The elements have pivotal arms engaging with the current applying gaps of the welding electrode for advancing it towards the workpiece as well as supplying the welding current for the welding operation. The construction of such driving device is rather complex and the circulating elements may often become jammed in the parallel tracks.

U.S. Pat. No. 7,115,835 issued Q. F. Jiang, the applicant, of the present application shows a reciprocating welding device having two side by side carriages moving in a reciprocating manner relative to one another. The carriages have grasping fingers alternately engageable with the current applying gaps of the continuous welding electrode for advancing it towards the workpiece. The grasping fingers are operated with a plurality of complex gearing systems driven by an arrangement having rotating crank shafts coupled to the motor for operating the carriages as well as the grasping fingers.

### SUMMARY OF THE INVENTION

It is a principal object of the present invention to provide a welding electrode driving system having a relatively simple construction yet operates more efficiently.

It is another object of the present invention to provide a welding electrode driving system having reciprocating carriages with jaw elements clasping and moving the welding electrode alternately continuously towards the work piece.

It is another object of the present invention to provide a welding electrode driving system in which the clasping jaw elements are operated by simple slider rods.

### BRIEF DESCRIPTION OF THE DRAWINGS

Other objects of this invention will appear in the following description and appended claims, reference being made to the accompanying drawings forming a part of the specification in which

FIG. 1 is a partial sectional elevation side view of the welding device according to the present invention.

FIG. 2 is a partial sectional top elevation view of the welding device thereof.

FIG. 3 is an isolated partial sectional side elevation view of the left carriage of the welding device showing the electrode driving system according to the present invention.

FIG. 4 is an isolated side elevation view of the reciprocating sliding rod of the driving system.

FIG. 5 is an isolated enlarged sectional front elevation view along section line V-V of the device shown in FIG. 4 with the jaw of the grasping elements in the closed position in contact with the metal core of the welding electrode.

FIG. 6 is an isolated enlarged sectional front elevation view with the jaw of the grasping elements in the opened position.

### DETAILED DESCRIPTION OF THE PREFERRED EMBODIMENT

With reference to the drawings wherein like reference numerals designate corresponding parts in the different views, the welding device 10 of the present invention has a main frame 11. A reciprocating electrode driving system 12 is slidably mounted at the top portion of the main frame 11. The continuous welding electrode 13 extends through the driving system 12. The welding electrode 13 has evenly spaced welding flux coating 14 formed on a continuous metal core 15. The electrode driving system 12 is operated by an electric motor 16 mounted to the main frame 11 and it is coupled to the electrode driving system 12 through a driving gear system 17 including a worm drive 18.

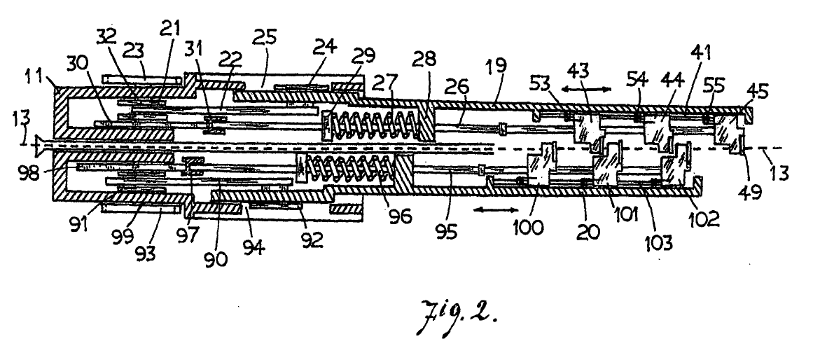

As best shown in FIG. 2, the electrode driving system 12 consists of two similar carriages 19 and 20 slidably mounted side by side to one another to the main frame 11. The carriages 19 and 20 have a mirror image construction of one another. The carriage 19 is coupled to a crank shaft 21 through a link arm 22. The crank shaft 21 is rotated by a drive wheel 23 coupled to the driving gear system 17. The link arm 22 is mounted to the carriage 19 with a T-shaped slider 24 so that the carriage 19 is moved in a reciprocating manner by the crank shaft 21 with respective to the main frame 11 for a distance limited by the length of the space 25 in which the slider 24 moves in a reciprocating manner back and forth accordingly.

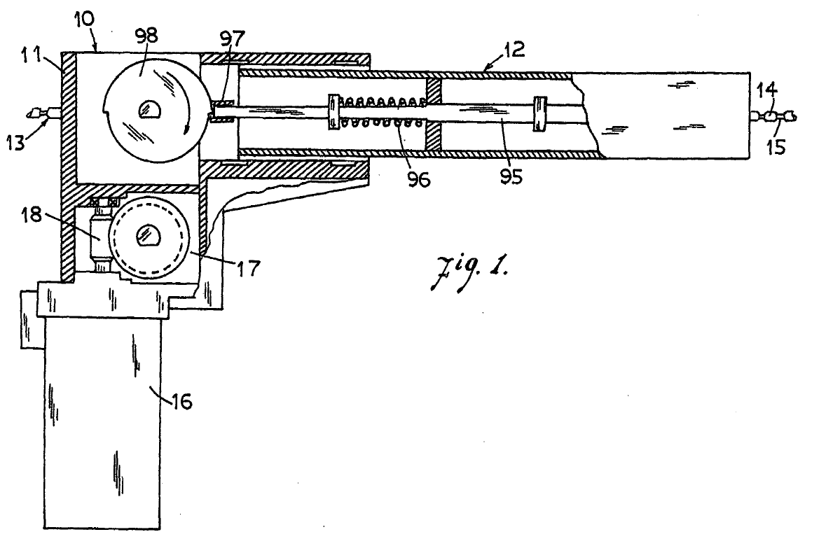

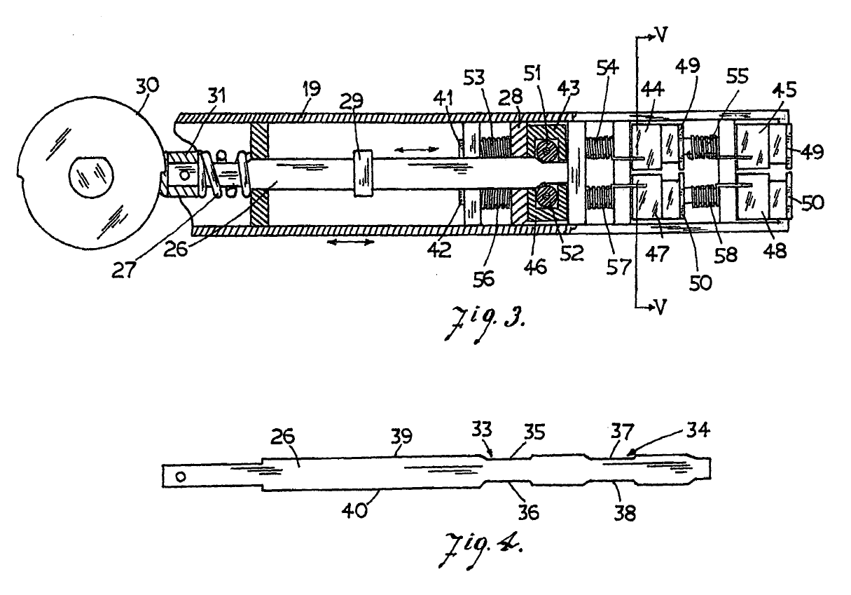

As best shown in FIGS. 2 to 6, an elongated slider rod 26 is slidably mounted longitudinally within the carriage 19. The slider rod 26 is biased by a compression spring 27 which is mounted around the rear portion of the slider rod 26 located between an abutment wall 28 within the carriage 19 and a retaining ring 29 secured to the slider rod 26. The compression spring 27 maintains the rear end of the slider rod 26 to abut the periphery of a cam wheel 30. A cap 31 is mounted at the rear end of the slider rod 26 to enhance the abutment contact between the end of the slider rod 26 and the cam wheel 30. The cam wheel 30 is mounted to the common shaft 32 of the drive wheel 23. Half of the cam wheel 30 has a larger diameter than the other half as best shown in FIGS. 1 and 3, such that the rotation of the cam wheel 30 will cause the slider rod 26 to move slidably in a reciprocating manner back and forth relative to the carriage 19. As shown in FIG. 4, the slider rod 26 has two narrower sections 33 and 34 formed in its outer portion. These narrower sections 33 and 34 are formed by equal length depressions 35 and 36, and 37 and 38 formed at the opposite upper surface 39 and lower surface 40 respectively.

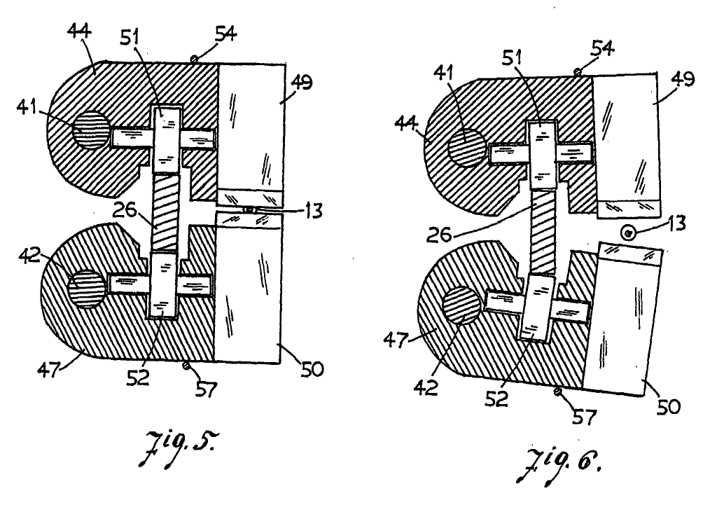

Three pairs of pivotal jaw elements are mounted pivotally on two mounting rods 41 and 42 mounted in the carriage 19. Upper pivotal jaw elements 43, 44 and 45 are pivotally mounted to the upper mounting rod 41 and the lower pivotal jaw elements 46, 47 and 48 are pivotally mounted to the lower mounting rod 42. The upper jaw element has an electrical conductive plate 49 mounted at its free end and the lower jaw element has a similar electrical conductive plate 50 mounted at its free end correspondingly. An upper rotary wheel 51 is mounted in each upper jaw element and a similar rotary wheel 52 is mounted in each lower jaw element. Torsion springs 53, 54 and 55 are mounted on the upper mounting rod 41 and the free ends of these torsion springs urge the upper jaw elements 43, 44 and 45 to pivot normally downwards relative to the upper mounting rod 41 with the rotary wheel 51 abutting and riding on the upper edge surface 39 of the slider rod 26. Similarly, torsion springs 56, 57 and 58 are mounted on the lower mounting rod 42 and the free ends of these torsion springs urge the lower jaw elements 46, 47 and 48 to pivot upwards relative to the lower mounting rod 42 with the rotary wheel 52 abutting and riding on the lower edge surface 40 of the slider rod 26. Alternatively, a single torsion spring may be provided for pivoting all the upper jaw elements 43, 44 and 45 as a group, and a second torsion spring may also be provided for pivoting the lower jaw elements 46, 47, 48 as a group. The upper and lower jaw elements will be in a closed position as shown in FIG. 5 to clamp on the metal core gap of the welding electrode 13 when the rotary wheels 51 and 52 are engaged with the narrow sections 33 and 34 of the slider rod 26; and they will be in the opened position as shown in FIG. 6 when the rotary wheels 51 and 52 are engaged with the normal sections of the slider rod 26.

The left carriage 20 has an identical construction as the right carriage 19 and consisting of link rod 59 connecting between the crank shaft 91 and a slider 92 mounted to the carriage 20. The crank shaft 91 is rotated by the drive wheel 93 which is coupled to the driving gear system 17. The carriage 20 moves in a reciprocating manner back and forth relative to the main frame 11 with the rotation of the crank shaft 91 and the distance of its movement is limited by the space 94 in the main frame 11 in which the slider 92 is moving back and forth. A slider rod 95 is mounted slidably on the carriage 20. The slider rod 95 is biassed by a compression spring 96. The slider rod 95 has the same shape and size as slider rod 26 and a cap 97 is mounted at its rear end which abuts the peripheral edge of the cam wheel 98. As the cam wheel 98 is rotated by the common rotary shaft 99 of the drive wheel 93, the slider rod 96 will move in a reciprocating manner back and forth relative to the carriage 20. Three pairs of jaw elements 100, 101 and 102 are mounted in a cantilever manner on mounting rods 103 (only the upper jaw elements and the upper mounting rod are visible in FIG. 2). Rotary wheels are mounted in the jaw elements, which abut and ride on the upper and lower edge surfaces of the slider rod 96 and torsion springs mounted to the mounting rods urge the upper and lower jaw elements of the pairs of jaw elements 100, 101 and 102 in a closed position. The upper and lower jaw elements are in the closed position when the rotary wheels therein are engaged with the narrow sections of the slider rod 96, and they are in the opened position when the rotary wheels therein are engaged with the other sections other than the narrow section of the slider rod 96.

As best shown in FIG. 2, the rotational position of the cam wheels 30 and 98 are 180 degrees out of phase with one another such that when the carriage 19 has moved to the most outward position, the carriage 20 has moved to the most inward position, and the carriage 19 and carriage 20 move in opposite directions. Also, when the jaw elements of the carriage 19 are in the closed position, the jaw elements of the carriage 20 would be in the opened position. In the closed position, the jaw elements are engaged with the gaps of the welding electrode such that the carriage would move forward to drive the welding electrode forwards, in the meantime, the other carriage would move backward with the jaw elements in the opened position. The carriages and the jaw elements operate alternately in the above manner so that the welding electrode is driven forward continuously by the two carriages moving alternately forward.

The electrical conductive plates 49 and 50 which engage with the metal core 15 of the welding electrode 13 when the latter is driven forward by the jaw elements in the closed position also conduct the welding current to the welding electrode 13 during the welding operation.

While the present invention has been shown and described in the preferred embodiment thereof, it will be apparent that various modifications can be made therein without departing from the spirit or essential attributes thereof, and it is desired therefore that only such limitations be placed thereon as are imposed by the appended claims.

What is claimed is:

1. A welding electrode driving system operative for driving a continuous welding electrode towards a workpiece, said electrode having a plurality of evenly spaced gaps formed in a welding flux coating exposing a continuous metal core therein, comprising:
a left carriage and a right carriage slidably mounted to a main frame, said left carriage and said right carriage being movable alternately in a reciprocating manner relative to said main frame,
an elongated slider rod slidably mounted in each of said left carriage and said right carriage, said slider rod having narrow sections formed by depressions located at opposite upper and lower edges along said slider rod,
a rotary cam wheel rotatably mounted in said main frame, said rotary cam having a cam periphery in contact with an inner end of said slider rod in each of said left carriage and said right carriage, and operative to move said slider rod in a reciprocating manner relative to each of said left carriage and said right carriage respectively,
a plurality of pairs of upper and lower jaw elements pivotally mounted in each of said left carriage and said right carriage and being engageable with said upper and lower edges of said slider rod,
torsion springs located in each of left carriage and said right carriage and operative to urge said jaw elements to abut said upper and lower edges of said slider rod in contact engagement, said pairs of upper and lower jaw elements of each of said left carriage and said right carriage being alternately closed to move said electrode towards said workpiece while said left carriage and said right carriage moving alternately in said reciprocating manner.

2. A welding electrode driving system according to claim 1 including a rotary wheel mounted in each pairs of upper and lower jaw elements, said rotary wheel engaging with said upper and lower edges of said slider rod in each of said left carriage and said right carriage for causing said pairs of jaw elements to open and close alternately as said left carriage and said right carriage moving in a reciprocating manner.

3. A welding electrode driving system according to claim 2 wherein each of said left carriage and said right carriage is connected to a crank shaft by a link rod, said left carriage and said right carriage being movable in said reciprocating manner by rotational movement of said crank shaft.

4. A welding electrode driving system according to claim 3 including an electric motor having a rotary shaft coupled to said crank shaft and said cam wheel of said left carriage and said right carriage through a driving gear system.

5. A welding electrode driving system according to claim 4 including an electrical conductive plate mounted on each jaw element of said pairs of jaw elements, said conductive plate being in contact with said metal core of said welding electrode when said jaw elements are in said closed position clamping on said electrode as said welding electrode being driven forward towards said workpiece for conducting welding current to said workpiece during welding operation.

6. A welding electrode driving system for driving a continuous welding electrode towards a workpiece, said electrode having a plurality of evenly spaced gaps formed in a welding flux coating exposing a continuous metal core therein, comprising
a first carriage and a second carriage having a mirror image construction of one another and located side by side to one another and being slidably mounted to a main frame, said first carriage being coupled to a first rotatable crank shaft by a first link arm, and said first carriage being movable in a reciprocating manner relative to said main frame by rotational movement of said first crank shaft, said second carriage being coupled to a second rotatable crank shaft by a second link arm, and said second carriage being movable in a reciprocating manner relative to said main frame by rotational movement of said second crank shaft, said first carriage and said second carriage being movable in opposite directions relative to one another,
an elongated first slider rod slidably mounted in said first carriage, said first slider rod having a plurality of narrow sections formed by depressions located at opposite upper and lower edges along a front portion therein,
a first rotary cam wheel rotatably mounted in said main frame, said first rotary cam having a cam periphery in contact with an inner end of said first slider rod, and said first slider rod being movable in a reciprocating manner relative to said first carriage by rotational movement of said first rotary cam wheel,
a elongated second slider rod slidably mounted in said second carriage and said second slider rod having a plurality of narrow sections formed by depressions located at opposite upper and lower edges along a front portion therein,
a second rotary cam wheel rotatably mounted in said main frame, said second rotary cam wheel having a cam periphery in contact with an inner end of said second slider rod, and said second slider rod being movable in a reciprocating manner relative to said second carriage by rotational movement of said second rotary cam wheel,
a plurality of pairs of upper and lower jaw elements pivotally mounted in a cantilever manner in said first carriage and having rotary wheels therein in contact engagement with said upper and lower edges respectively of said front portion of said first slider rod, said upper and lower jaw elements being in a closed position clamping on said metal core of said welding electrode at said gaps in said welding flux coating when said rotary wheels are in contact with said narrow sections of said first slider rod,
a plurality of pairs of upper and lower jaw elements pivotally mounted in a cantilever manner in said second carriage and having rotary wheels therein in contact engagement with said upper and lower edges respectively of said front portion of said second slider rod, said upper and lower jaw elements being in a closed position clamping on said metal core of said welding electrode at said gaps in said welding flux coating when said rotary wheels are in contact with said narrow sections of said second slider rod,
torsion springs located in each of said first carriage and said second carriage and operative to urge said rotary wheels in said jaw elements to contact said upper and lower surfaces of said first slider rod and said second slider rod.

7. A welding electrode driving system according to claim 6 wherein said first cam wheel and said second cam wheel have half circular arc periphery with a larger diameter than the other half circular arc periphery.

8. A welding electrode driving system according to claim 7 wherein said jaw elements in said first carriage are pivotally mounted on a first mounting rod located in said first carriage, and said jaw elements in said second carriage are pivotally mounted on a second mounting rod located in said second carriage.

9. A welding electrode driving system according to claim 8 wherein said jaw elements in said first carriage and said jaw elements in said second carriage are alternately in a closed position and an opened position, and said first carriage and said second carriage move in a reciprocating manner in opposite directions.

10. A welding electrode driving system according to claim 9 wherein said jaw elements are in an opened position when said rotary wheels in said jaw elements in each of said first carriage and said second carriage are in contact engagement with said upper and lower surfaces of said first slider rod and said second slider rod respectively in said front portion other than said narrow sections.

11. A welding electrode driving system according to claim 10 including an electric motor mounted on said main frame and operative for rotating said first crank shaft, said second crank shaft, said first cam wheel and said second cam wheel.
